(19) United States
(12) Patent Application Publication
(10) Pub. No.: US 2006/0007958 A1
(43) Pub. Date: Jan. 12, 2006

(54) Multiplexing method and apparatus to generate transport stream

(75) Inventors: Hee-beom Kang, Hwaseong-si (KR); Choon-sik Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/106,573

(22) Filed: Apr. 15, 2005

(30) Foreign Application Priority Data
Jul. 12, 2004 (KR) 10-2004-0054095

(51) Int. Cl. H04J 3/00

(52) U.S. Cl. 370/476

(57) ABSTRACT

A multiplexing method and apparatus are provided to generate a transport stream. According to the multiplexing method, multiplexing is performed for each access unit, an insertion interval for null transport stream packets, an insertion interval for video transport stream packets, and an insertion interval for audio transport stream packets are calculated, and a transport stream is generated by inserting the video transport stream packets, the audio transport stream packets, and the null transport stream packets to fit into the insertion intervals.

### BACKGROUND OF THE INVENTION

This application claims priority from Korean Patent Application No. 10-2004-0054095, filed on Jul. 12, 2004, in the Korean Intellectual Property Office, the disclosure of which is incorporated herein in its entirety by reference.

1. Field of the Invention

Apparatuses and methods consistent with the present invention relate to multiplexing to generate a transport stream, and more particularly, to efficient and simple multiplexing method and apparatus that maintain a constant transmission bit rate.

2. Description of the Related Art

Video and/or audio data that are generated according to a data compression standard such as Moving Picture Experts Group (MPEG) are divided into data of a predetermined size for transmission or storage, synchronized together, and then multiplexed. MPEG systems use packet-based multiplexing that is adopted in time division multiplexing techniques. In particular, MPEG-2 systems use two forms of multiplexed streams, i.e., a program stream and a transport stream, so as to be applied to various application fields. A program stream can form one program and a transport stream can form a plurality of programs. Since a transport stream can form a plurality of programs with one bit stream, it is usually used for TV broadcast.

Conventional multiplexing techniques that are intended to generate a transport stream according to the MPEG-2 system standard are complex because they are required to check states of an input buffer and an output buffer during processing, and it is difficult to maintain a predetermined transmission bit rate using the conventional multiplexing techniques.

### SUMMARY OF THE INVENTION

The present invention provides effective and simple multiplexing method and apparatus that maintain a constant transmission bit rate.

According to an aspect of the present invention, there is provided a multiplexing method by which a transport stream of a predetermined size is generated by multiplexing a plurality of video transport stream packets, a plurality of audio transport stream packets, and a plurality of null transport stream packets. The multiplexing method includes (a) calculating a size S1 of a transport stream corresponding to one access unit, (b) calculating a total size S2 of the plurality of video transport stream packets to be included in the transport stream and a total size S3 of the plurality of audio transport stream packets, (c) calculating a total size S4 of the plurality of null transport stream packets to be included in the transport stream by subtracting the total size S2 and the total size S3 from the size S1, (d) calculating an insertion interval I1 for the null transport stream packets, an insertion interval I2 for the video transport stream packets, and an insertion interval I3 for the audio transport stream packets using the total size S2 and the total size S3 from the size S1, and (e) creating a transport stream by inserting the plurality of video transport stream packets, the plurality of audio transport stream packets, and the plurality of null transport stream packets respectively to fit into the insertion interval I1, the insertion interval I2, and the insertion interval I3.

According to another aspect of the present invention, there is provided a multiplexing apparatus which generates a transport stream of a predetermined size by multiplexing a plurality of video transport stream packets, a plurality of audio transport stream packets, and a plurality of null transport stream packets. The multiplexing apparatus includes a scheduler and a multiplexing unit. The scheduler calculates a size S1 of a transport stream corresponding to one access unit, calculates a total size S2 of the plurality of video transport stream packets to be included in the transport stream and a total size S3 of the plurality of audio transport stream packets, calculates a total size S4 of the plurality of null transport stream packets to be included in the transport stream by subtracting the total size S2 and the total size S3 from the size S1, and calculates an insertion interval I1 for the null transport stream packets, an insertion interval I2 for the video transport stream packets, and an insertion interval I3 for the audio transport stream packets using the total size S2 and the total size S3 from the size S1. The multiplexing unit generates a transport stream by inserting the plurality of video transport stream packets, the plurality of audio transport stream packets, and the plurality of null transport stream packets respectively to fit into the insertion interval I1, the insertion interval I2, and the insertion interval I3.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart illustrating a multiplexing method according to an exemplary embodiment of the present invention;

FIG. 2 is a block diagram of a multiplexing apparatus according to an exemplary embodiment of the present invention;

FIG. 3 shows a transport stream that is generated according to an exemplary embodiment of the present invention;

FIG. 4 shows a transport stream that is generated according to another exemplary embodiment of the present invention; and

FIG. 5 is a block diagram of a data encoding system that includes the multiplexing apparatus according to the exemplary embodiment of the present invention.

### DETAILED DESCRIPTION OF THE INVENTION

In a multiplexing method according to the present invention, multiplexing is performed for each access unit. In the case of video, an access unit represents a picture and in the case of audio, a frame. When an access unit is a video picture, an entire transport stream size, a video transport stream size, an audio transport stream size, and a null transport stream size, which pertain to a video picture to be multiplexed, are calculated using a video picture size, a video bit rate, and a multiplexing bit rate. Also, insertion intervals for a video transport stream, an audio transport stream, and a null transport stream are calculated using ratios of the video transport stream size, the audio transport stream size, and the null transport stream size to the entire transport stream size.

Packets of each of the video transport stream, the audio transport stream, and the null transport stream are selected by a scheduler to fit into the corresponding calculated insertion interval, and the selected packets are subject to multiplexing. Also, a difference between an entire transport stream size that is a product of the multiplexing and the calculated entire transport stream size pertaining to the video picture to be multiplexed is calculated, and the calculated difference is applied to scheduling for a current access unit to be processed for compensation. Thus, a constant transmission bit rate can be maintained in the course of multiplexing.

Also, in the present invention, a transport packet (TP) extra header of four bytes is inserted in front of a transport packet of 188 bytes, thereby creating a source packet of 192 bytes for an MPEG-2 transport stream. Whether to append the transport packet extra header of four bytes can be determined by a user.

A multiplexing apparatus according to the present invention multiplexes for each access unit an audio elementary stream and a video elementary stream that are stored by an audio/video encoder in specific different areas of an external memory. To perform multiplexing for each access unit (e.g., a video picture), an entire transport stream is created by inserting program specific information (PSI), null packets, audio packets, and video packets respectively to fit into a corresponding insertion interval and is then recorded in a transport stream area of the external memory.

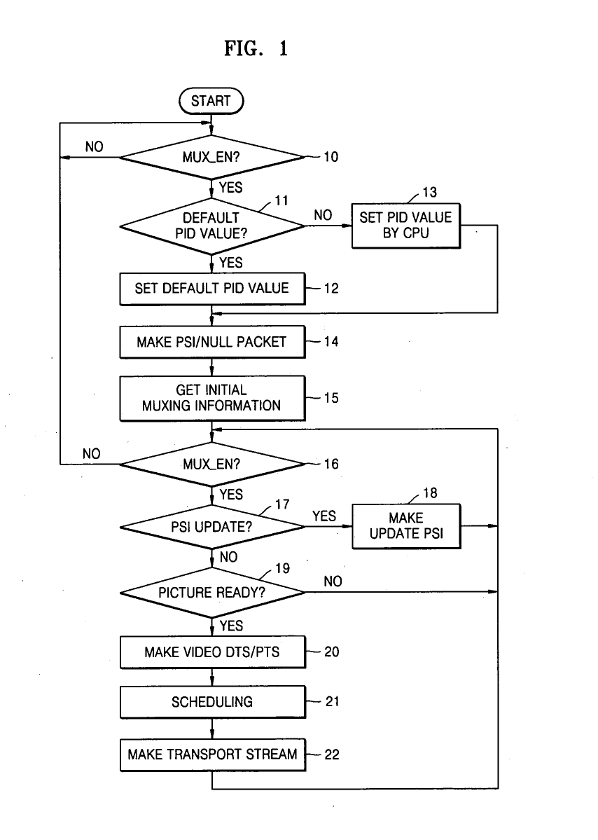

FIG. 1 is a flowchart illustrating a multiplexing method according to an exemplary embodiment of the present invention.

It is determined whether a multiplexing unit is activated in its initial state in operation (global change) 10, and it is determined whether to use a default PID (packet identifier) value in operation 11. In other words, PID setting conditions are determined.

According to a result of the determination of operation 11, a default PID value is set in operation 12 or a PID value is set by a CPU in operation 13. The default PID value and the PID value that is set by the CPU are defined inside a device according to user's selection or given from the outside of the device.

A PSI packet and a null packet are generated in an initial state of a system in operation 14 and are then stored in a PSI/null area of the external memory. The null packet is inserted to fit into a stuff interval that is determined according to a multiplexing bit rate, a video bit rate, and an audio bit rate, thereby generating transport stream (TS) packets.

In this exemplary embodiment, the PSI packet is inserted once per three pictures every 0.1 second to fit into the stuff interval. The stuff interval means an insertion interval for a null packet. Since the PSI packet is also regarded as the null packet and is scheduled, it is inserted to fit into the stuff interval.

In operation 15, initial multiplexing information is retrieved to calculate its fixed values in advance, store results of the calculation, and then use the stored values in a process following later.

Hereinafter, equations for calculating the fixed values and objects of using the fixed values will be described. An arrival time stamp offset value is calculated in advance according to a given multiplexing bit rate. To generate a source packet of 192 bytes for a BDAV MPEG-2 transport stream, a TP extra header of four bytes is inserted in front of a transport packet of 188 bytes. Whether to insert the TP extra header of four bytes can be selected by a user. An arrival time stamp is arrival time information of 30 bits included in the TP extra header of four bytes.

Equation 1 is used for calculation of the arrival time stamp offset value.
arrival_time_stamp_offset=(TS_SIZE*27M_CLOCK*8)/Muxing_Bit_Rate (1),
where TS_SIZE is 188 bytes and 27M_CLOCK is 27 MHz.

The calculated arrival time stamp offset value is defined as prefix_pcr_time in advance. Thus, the amount of computation is reduced when a program clock reference (PCR) is calculated using Equation 2.
PCR=ts_count*prefix_pcr_time (2),
where ts_count represents the number of accumulated TS packets.

In the case of audio, AUDIO_FRAME_SIZE and AUDIO_BIT_RATE maintain initially set fixed values. Thus, rate_ts_audio, Audio_interval, and audio_frame_rate that are required for subsequent processes like scheduling are calculated using AUDIO_FRAME_SIZE and AUDIO_BIT_RATE in advance. A corresponding equation is as follows.
audio_PES_size=AUDIO_FRAME_SIZE+PES_header_size (3)
where in the case of audio, PES_header_size is calculated as follows.
PES_header_size(14 bytes)=packet_start_code_prefix(3)+stream_id(1)+PES_packet_length(2)+PES scrambling control, PES priority, data alignment indicator, copyright, original or copy(1)+7flags(1)+PES header data length(1)+PTS(5) (4),
rate_ts_audio(bit/sec)=(no_{—}TS_audio*TS_SIZE*AUDIO_BIT_RATE)/AUDIO_FRAME_SIZE (5),
where no_TS_audio of Equation 5 is as follows.
no_{—}TS_audio_{—}PES_size/MAX_PAYLOAD (6)

MAX_PAYLOAD of Equation 6 is 184 bytes in this exemplary embodiment and no_TS_audio represents the number of audio TS packets per audio frame.

It is checked if PSI_UPDATE is done from outside for each access unit in operation 17, and a PSI packet is updated for each checked item in operation 18.

An access unit (e.g., a video picture) to be multiplexed waits for in operation 19. Once the access unit is ready to be processed and is then processed, a decoding time stamp (DTS) and a presentation time stamp (PTS) that are to be included in a packetized elementary stream (PES) header are calculated in operation 20.

Scheduling for multiplexing for each access unit is performed using a video picture size, a video bit rate, and a multiplexing bit rate in operation 21.

Operation 21 will be described in greater detail. Here, an access unit is a picture and the size of an entire transport stream to be multiplexed for a current access unit, i.e., total_ts_size is calculated as follows.
total_{—}ts_size=(video_picture_size/video_bit_rate)*MUXING_BIT_RATE (7)

After fixed values, i.e., a video PES header and an adaptation field size, are added to the video picture size, a result of the addition is divided by a payload size of 184 bytes that is a product of subtracting the TS header of four bytes from the TS packet of 188 bytes and the number of entire video transport stream (TS) packet is calculated. The entire video transport stream size is obtained by multiplying the calculated number by 188 bytes of the TS packet size.
video_{—}TS_size=video_πcture_size+PES_header_size (8)
where PES_header_size is calculated as follows.
PES_header_size(19 bytes)=packet_start_code_prefix(3)+stream_id(1)+PES_packet_length(2)+PES scrambling control, PES priority, data alignment indicator, copyright, original or copy(1)+7flags (1)+PES header data length (1)+PTS(5)+DTS(5) (9)

The number of entire video TS packet is calculated as follows.
no_{—}TS_video=(video_{—}PES_size+ADAPTATION_FIELD_LENGTH+1)/MAX_PAYLOAD (10),
where MAX_PAYLOAD is 184 bytes, no_TS_video represents the number of video TS packets for one picture, and ADAPTATION_FIELD_LENGTH is calculated as follows.
ADAPTATION_FIELD_LENGTH (7 byte)=discontinuity indicator, random access indicator, elementary stream priority indicator, 5 flags (1)+PCR (6) (11)

The entire size of a plurality of video TS packets to be included in a currently generated transport stream, i.e., size_TS_video, is calculated using the number of entire video TS packet, i.e., no_TS_video that is calculated using Equation 10, as follows.
size_{—}TS_video=no_{—}TS_video*TS_SIZE (12)

In this exemplary embodiment, TS_SIZE is 188 bytes.

Also, using a result of the above calculation, the entire size of a plurality of audio TS packets to be included in the currently generated transport stream, i.e., size_TS_audio, is calculated as follows.
size_{—}TS_audio=(rate_{—}TS_audio/MUXING_BIT_RATE)*total_{—}TS_size (13),
where rate_TS_audio is already calculated in operation 15, MUXING_BIT_RATE is a bit rate of a transport stream and is expressed in units of bits/sec, and rate_TS_audio is a bit rate of audio data included in the transport stream.

A PSI packet is inserted once per three video pictures. In other words, the PSI packet is inserted every 0.1 second. Thus, size_TS_psi is determined according to whether the PSI packet is inserted, as follows.
if(vframe_cnt %3==0)
   size_TS_psi=TS_size_{—}3;
else
   size_TS_psi=0,
where TS_SIZE_{—}3 is a product of multiplying 188 bytes by 3. When size_TS_psi is not 0, PAT, PMT, and SIT are inserted to fit into the stuff interval with the highest priority.

The entire size of a plurality of null transport stream (TS) packets, i.e., size_TS_stuff is calculated using the calculated total_TS_size, size_TS_video, and size TS audio as follows.
size_{—}TS_stuff=total_{—}TS_size−size_{—}TS_video−size_{—}TS_audio (14)

Next, an insertion interval I1 for the null TS packets, an insertion interval I2 for the video TS packets, and an insertion interval I3 for the audio transport stream (TS) packets are calculated using the calculated size_TS_stuff, total_TS_size, size_TS_video, and rate_TS_audio as follows.
I1=(total_{—}TS_size*TS_size)/size_{—}TS_stuff (15)
I2=(total_{—}TS_size*TS_size)/size_{—}TS_video
I3=(MUXING_BIT_RATE*TS_size)/rate_{—}TS_audio (17)

The plurality of video TS packets, the plurality of audio TS packets, and the plurality of null TS packets are multiplexed based on the calculated insertion intervals I1, I2, and I3, thereby generating a transport stream for a current picture in operation 22.

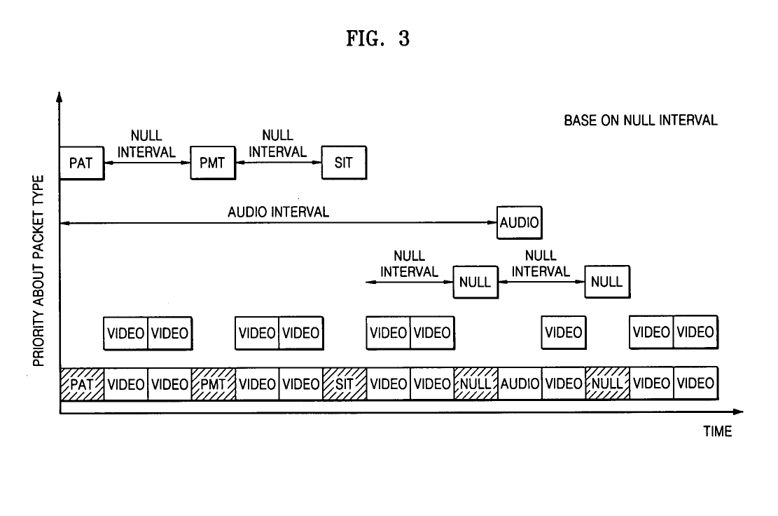

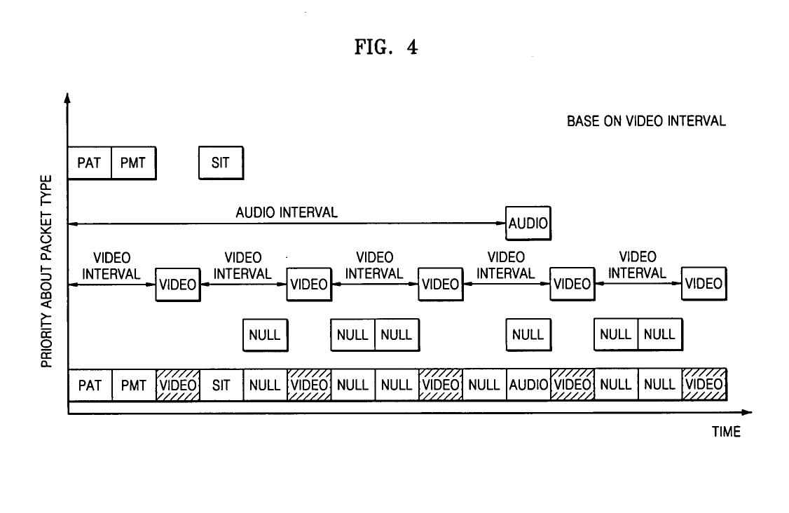

FIGS. 3 and 4 show exemplary transport streams that are generated according the present invention. FIG. 3 shows a transport stream that is generated when size_TS_video is greater than size_TS_stuff. FIG. 4 shows a transport stream that is generated when size_TS_video is less than size_TS_stuff. In FIGS. 3 and 4, the X-axis represents time and the Y-axis represents the priority in multiplexing of various packets. In FIG. 3, when size_TS_video is greater than size_TS_stuff, the priority is given in order of PSI packets, such as PAT, PMT, and SIT, audio packets, null packets, and then video packets. In FIG. 4, when size_TS_video is less than size_TS_stuff, the priority is given in order of PSI packets, such as PAT, PMT, and SIT, audio packets, video packets, and then null packets.

Although not shown in drawings as separate operations, there is an operation of compensating for errors that occur when multiplexing is performed for each access unit (e.g., a video picture). Error compensation is done to maintain a predetermined transmission bit rate by adjusting at least one of the insertion interval I1 for the null TS packets, the insertion interval I2 for the video TS packets, and the insertion interval I3 for the audio TS packets that are required for generation of the current transport stream with reference to a transmission bit rate for a previously generated transport stream and the number of multiplexed transport stream packets.

Error compensation is done for two cases.
I. Case 1 (when size_TS_video>size_TS_stuff)

Case 1 is a case when size_TS_video is greater than size_TS_stuff. Thus, the predetermined transmission bit rate is maintained by adjusting a stuff interval.

When result_total_cnt>cal_total_cnt, compensated size_TS_stuff is determined as follows.
size_{—}TS_stuff=size_{—}TS_stuff−TS_SIZE*(result_total_{—}cnt−cal_total_{—}cnt) (18)

However, when result_total_cnt<cal_total_cnt, compensated size_TS_stuff is determined as follows.
size_{—}TS_stuff=size_{—}TS_stuff+TS_SIZE*(cal_total_{—}cnt−result_total_{—}cnt) (19),
where result_total_cnt represents the total number of TS packets that are substantially multiplexed when a previous picture is multiplexed and cal_total_cnt represents the total number of TS packets that are obtained through calculation during scheduling before multiplexing the previous picture.

In case 1, since the total number of TS packets that are generated by multiplexing the previous picture is greater than the total number of TS packets that are estimated through calculation, a stuff interval is increased by reducing size_TS_stuff, thereby reducing the total number of TS packets that are generated for a picture to be multiplexed.
II. Case 2 (when size_TS_video<size_TS_stuff)

Case 2 is a case when size_TS_stuff is greater than size_TS_video. Thus, a predetermined bit rate is maintained by adjusting video_interval.

In case 2, since the total number of TS packets that are estimated through calculation as a result of multiplexing a previous picture is greater than the total number of TS packets that are generated, a stuff interval is reduced by increasing size_TS_stuff by a difference therebetween, thereby increasing the total number of generated TS packets. Therefore, scheduling can be performed while maintaining a predetermined transmission bit rate.

When result_total_cnt>cal_total_cnt, compensated size_TS_video is determined as follows.
size_{—}TS_video=size_{—}TS_video+TS_SIZE*(result_total_{—}cnt−cal_total_{—}cnt) (20)

However, when result_total_cnt<cal_total_cnt, compensated size_TS_video is determined as follows.
size_{—}TS_video=size_{—}TS_video−TS_SIZE*(cal_total_{—}cnt−result_total_{—}cnt) (21)

As described above, size_TS_stuff and size_TS_video are compensated for with a difference between the total number of TS packets that is calculated for the previous picture and the total number of TS packets that are substantially generated, thereby adjusting the stuff interval and the video interval. Thus, a scheduling error that occurs with respect to the previous picture is compensated for during processing of the current picture.

Since the present invention performs multiplexing for each access unit (e.g., a video picture), if a video interval is increased, a large number of TS_stuff is inserted accordingly to complete processing of a current picture, resulting in an increase in the total number of TS packets. On the other hand, if a video interval is reduced, processing of a current picture is completed earlier and a small number of TS_stuff is inserted, resulting in a decrease in the total number of TS packets.

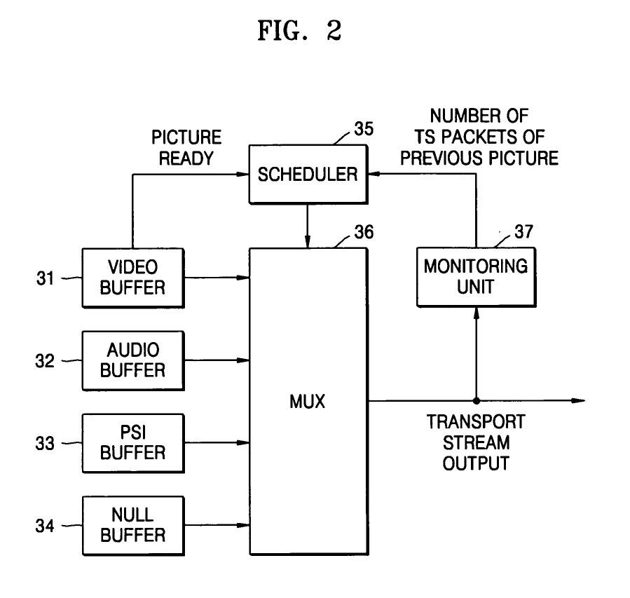

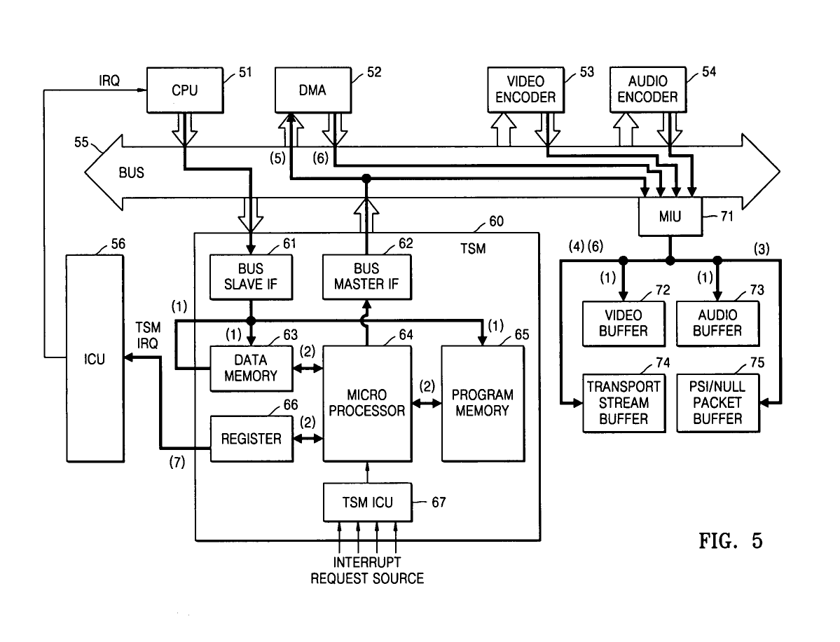

FIG. 2 is a block diagram of a multiplexing apparatus according to an exemplary embodiment of the present invention. FIG. 5 is a block diagram of an encoding system including the multiplexing apparatus according to an exemplary embodiment of the present invention. Referring to FIG. 2, the multiplexing apparatus includes a video buffer 31, an audio buffer 32, a PSI buffer 33, a null buffer 34, a scheduler 35, a multiplexing unit (mux) 36, and a monitoring unit 37.

The video buffer 31 stores video elementary streams created by a video encoder 53 shown in FIG. 5. The audio buffer 32 stores audio elementary streams created by an audio encoder 54. The PSI buffer 33 stores PSI packets generated in operation 14 as shown in FIG. 1 and the null buffer 34 stores and null packets that are generated in operation 14 as shown in FIG. 1.

The scheduler 35 calculates a size S1 of a transport stream that corresponds to one access unit, a total size S2 of a plurality of video TS packets to be included in the transport stream, a total size S3 of a plurality of audio TS packets, and a total size S4 of a plurality of null TS packets to be included in the transport stream by subtracting S2 and S3 from S1, and calculates the insertion interval for the null TS packets, the insertion interval for the video TS packets, and the insertion interval for the audio TS packets using S1, S2, S3, and S4. The scheduler 35 controls the multiplexing unit 36 to insert the plurality of video TS packets, the plurality of audio TS packets, and the plurality of null TS packets to fit into the insertion interval for the null TS packets, the insertion interval for the video TS packets, and the insertion interval for the audio TS packets and generate a transport stream.

To compensate for an error that occurs when multiplexing is performed based for each access unit (e.g., a video picture), the monitoring unit 37 recognizes the number of TS packets that are substantially included in a transport stream corresponding to a previous picture and provides the recognized number to the scheduler 35. The scheduler 35 compares the number of TS packets included in a transport stream corresponding to the previous picture, which is provided from the monitoring unit 37, and the number of TS packets, which is calculated before multiplexing is performed for the previous picture, and compensates for an error that occurs when multiplexing is performed for each access unit (e.g., a video picture).

The scheduler 35 determines the type of TS packets to be inserted according to whether a PSI packet is inserted and according to conditions such as a stuff interval, a video interval, and an audio interval and informs the determined type of the multiplexing unit 36.

Also, since the PSI packet stored in the PSI buffer 33 is recognized as a null packet and then scheduled, it is inserted into a transport stream by the multiplexing unit 36 to fit into the stuff interval under the control of the scheduler 35.

In the case of video TS packets that are first generated for a new video picture, a TS header (adaptation field) and a PES header are recorded in a transport stream buffer 74 in byte units, and the TS header and the PES header whose sizes are large enough to generate a TS packet of 188 bytes are recorded in the transport stream buffer 74 from a video buffer 72 through a DMA 52. Thereafter, until a new video picture is received, only a TS header of four bytes is recorded in the transport stream buffer 74 in byte units and a video elementary stream of 184 bytes is recorded in the transport stream buffer 74 from the video buffer 72 through the DMA 52.

In the case of audio data, an audio transport stream is calculated every time when a new audio frame is processed. In the case of an audio TS packet that is first generated for a new audio frame, a TS header and a PES header are recorded in a transport stream area of the transport stream buffer 74 in byte units, and the TS header and the PES header whose sizes are large enough to generate a transport stream packet of 188 bytes are recorded in the transport stream buffer 74 from an audio buffer 73 through the DMA 52. Thereafter, until a new audio frame is processed, only a TS header is recorded in the transport stream buffer 74 in byte units and an audio elementary stream of 184 bytes is recorded in the transport stream buffer 74 from the audio buffer 73 through the DMA 52.

Hereinafter, the operation of the encoding system including the multiplexing apparatus according to an exemplary embodiment of the present invention, which is shown in FIG. 5, will be described. The video buffer 31 and the audio buffer 32 that are shown in FIG. 2 correspond to a video buffer 72 and an audio buffer 73 that are shown in FIG. 5, respectively. Also, the PSI buffer 33 and the null buffer 34 that are shown in FIG. 2 correspond to a PSI/null buffer 75 of FIG. 5. The scheduler 35, the multiplexing unit 36, and the monitoring unit 37 that are shown in FIG. 2 correspond to a transport stream multiplexer (TSM) 60. The TSM 60 includes a bus slave IF 61, a bus master IF 62, a data memory 63, a microprocessor 64, a program memory 65, and a register 66.

The TSM 60 is connected to a bus 55 and is controlled by a central processing unit (CPU) 51. Operations will be described in order of number shown in FIG. 5.
(1) The operation of a system starts and a program is loaded into a program memory 65 of a TSM 60. The video encoder 53 and the audio encoder 54 operate, a video elementary stream is stored in the video buffer 72, and an audio elementary stream is stored in the audio buffer 73. A video/audio parameter required for multiplexing is recorded in the data memory 63 and the register 66.
(2) Once a picture ready signal is generated from the video encoder 53, multiplexing to generate a transport stream is performed as shown in the flowchart of FIG. 1.
(3) First, PSI/null packest to be used as fixed values are recorded in a PSI/null packet buffer 75.
(4) A TP extra header, a TS header, and a PES header are recorded in the transport stream buffer 74.
(5) The DMA 52 is informed of source addresses of an effective payload size to be transmitted and an elementary stream buffer (video, audio, and PSI/null) and a target address of a transport stream.
(6) A corresponding elementary stream is recorded in the transport stream buffer 74 by the DMA 52.
(7) When the transport stream buffer 74 is full or other errors occur during the operation of the TSM 60, an interrupt signal is transmitted from the TSM 60 to the CPU 51.

As described above, according to the present invention, multiplexing is performed for each access unit, and when a current access unit is multiplexed, compensation is done using a result of multiplexing of a previous access unit, thereby effectively and easily maintaining a constant transmission bit rate.

The present invention can also be embodied as a computer readable code on a computer-readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multiplexing method by which a transport stream of a predetermined size is generated by multiplexing a plurality of video transport stream packets, a plurality of audio transport stream packets, and a plurality of null transport stream packets, the multiplexing method comprising:
(a) calculating a size S1 of a transport stream corresponding to one access unit;
(b) calculating a total size S2 of the video transport stream packets to be included in the transport stream and a total size S3 of the audio transport stream packets to be included in the transport stream;
(c) calculating a total size S4 of the null transport stream packets to be included in the transport stream by subtracting the total size S2 and the total size S3 from the size S1;
(d) calculating an insertion interval I1 for the null transport stream packets, an insertion interval I2 for the video transport stream packets, and an insertion interval I3 for the audio transport stream packets using the sizes S1, S2, S3 and S4; and
(e) creating the transport stream by inserting the video transport stream packets, the audio transport stream packets, and the null transport stream packets to fit into the insertion interval I1, the insertion interval I2, and the insertion interval I3, respectively.

2. The multiplexing method of claim 1, wherein the insertion interval 11 for the null transport stream packets is calculated as
I1=(S1/S4)*(a size of one transport stream packet).

3. The multiplexing method of claim 1, wherein the insertion interval I2 for the video transport stream packets is calculated as
I2=(S1/S2)*(a size of one transport stream packet).

4. The multiplexing method of claim 1, wherein the insertion interval I3 for the audio transport stream packets is calculated as
I3=(MUXING_BIT_RATE/rate_TS_audio)*(a size of one transport stream packet), where MUXING_BIT_RATE represents a bit rate for the transport stream and is expressed in units of bits/second and rate_TS_audio represents a bit rate for audio data included in the transport stream and is expressed in units of bits/second.

5. The multiplexing method of claim 1, further comprising (f) maintaining a predetermined transmission bit rate by adjusting at least one of the insertion interval I1, the insertion interval I2, and the insertion interval I3 that are required for generation of a current transport stream with reference to a transmission bit rate for a previous transport stream that is generated in (a) through (e).

6. The multiplexing method of claim 1, wherein the access unit is a picture in the case of video data and a frame in the case of audio data.

7. A multiplexing apparatus which generates a transport stream of a predetermined size by multiplexing a plurality of video transport stream packets, a plurality of audio transport stream packets, and a plurality of null transport stream packets, the multiplexing apparatus comprising:
a scheduler which calculates a size S1 of a transport stream corresponding to one access unit, calculates a total size S2 of the video transport stream packets to be included in the transport stream and a total size S3 of the audio transport stream packets to be included in the transport stream, calculates a total size S4 of the null transport stream packets to be included in the transport stream by subtracting the total size S2 and the total size S3 from the size S1, and calculates an insertion interval I1 for the null transport stream packets, an insertion interval I2 for the video transport stream packets, and an insertion interval I3 for the audio transport stream packets using the sizes S1, S2, S3 and S4; and
a multiplexing unit which generates a transport stream by inserting the video transport stream packets, the audio transport stream packets, and the null transport stream packets to fit into the insertion interval I1, the insertion interval I2, and the insertion interval I3, respectively.

8. The multiplexing apparatus of claim 7, wherein the insertion interval I1 for the null transport stream packets is calculated as
I1=(S1/S4)*(a size of one transport stream packet).

9. The multiplexing apparatus of claim 7, wherein the insertion interval I2 for the video transport stream packets is calculated as
I2=(S1/S2)*(a size of one transport stream packet).

10. The multiplexing apparatus of claim 7, wherein the insertion interval I3 for the audio transport stream packets is calculated as
I3=(MUXING_BIT_RATE/rate_TS_audio)*(a size of one transport stream packet), where MUXING_BIT_RATE represents a bit rate for the transport stream and is expressed in units of bits/second and rate_TS_audio represents a bit rate for audio data included in the transport stream and is expressed in units of bits/second.

11. The multiplexing apparatus of claim 7, wherein the scheduler maintains a predetermined transmission bit rate by adjusting at least one of the insertion interval I1, the insertion interval I2, and the insertion interval I3 that are required for generation of a current transport stream with reference to a transmission bit rate for a previous transport stream.

12. The multiplexing apparatus of claim 7, wherein the access unit is a picture in the case of video data and a frame in the case of audio data.

13. A computer-readable recording medium having recorded thereon a program for performing a multiplexing method by which a transport stream of a predetermined size is generated by multiplexing a plurality of video transport stream packets, a plurality of audio transport stream packets, and a plurality of null transport stream packets, the multiplexing method comprising:
(a) calculating a size S1 of a transport stream corresponding to one access unit;
(b) calculating a total size S2 of the video transport stream packets to be included in the transport stream and a total size S3 of the audio transport stream packets to be included in the transport stream;
(c) calculating a total size S4 of the null transport stream packets to be included in the transport stream by subtracting the total size S2 and the total size S3 from the size S1;
(d) calculating an insertion interval I1 for the null transport stream packets, an insertion interval I2 for the video transport stream packets, and an insertion interval I3 for the audio transport stream packets using the sizes S1, S2, S3 and S4; and
(e) creating the transport stream by inserting the video transport stream packets, the audio transport stream packets, and the null transport stream packets to fit into the insertion interval I1, the insertion interval I2, and the insertion interval I3, respectively.
